(19) United States
(12) Patent Application Publication
(10) Pub. No.: US 2008/0156164 A1
(43) Pub. Date: Jul. 3, 2008

(54) Laborsaving hole puncher

(75) Inventor: Chi-Feng Huang, Hemei Chen (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SDI Corporation, Chang Hua (TW)

(21) Appl. No.: 11/648,085

(22) Filed: Dec. 29, 2006

(51) Int. Cl. B26F 1/14; B26D 5/08

(52) U.S. Cl. 83/687; 83/599

(57) ABSTRACT

A laborsaving hole puncher has a base, at least one cutter, a top cover and at least one articulated linkage. The base has at least one bracket. The least one cutter slidably is mounted respectively on the at least one bracket. The top cover is mounted pivotally on the at least one bracket. The least one articulated linkage connects respectively to the at least one bracket, the at least one cutter and the top cover and each articulated linkage has an upper link and a lower link. The upper link is mounted pivotally on the top cover. The lower link is mounted pivotally on the upper link and is mounted pivotally on one bracket and has an intermediate segment mounted to one cutter. The at least one articulated linkage makes people easily conveniently use the laborsaving hole puncher without strenuous effort.

### BACKGROUND OF THE INVENTION

1. Field of the Invention

The present invention relates to a hole puncher, and more particularly to a laborsaving hole puncher that allows a user to easily punch holes through a stack of paper sheets without strenuous effort.

2. Description of Related Art

Paper punchers are used to punch holes through paper sheets so the paper sheets can be mounted in a loose-leaf binder through the punched holes in the paper sheets.

With reference to FIG. 12, a conventional hole puncher has a base (90), two brackets (91), two cutters (92) and a cover (93). The brackets (91) are mounted on the base (90). The cutters (92) are mounted respectively on the brackets (91) and selectively moves up and down to cut paper sheets. The cover (93) is mounted pivotally on the brackets (91) and selectively drives the cutters (92) to move up and down. When hole puncher is used, a user depresses the cover (93) with one hand. A ratio of an input force from the user and an output force that the cutters (92) provide to paper sheets is about 1:7.

A large-scale company has many divisions specializing respectively in different works. An employee designated to do general affairs such as book-bind may punch holes through paper sheets all day long. Such an employee working on general affairs is probably a female being weak. After repetitively operating the hole puncher, the employee's hand feels uncomfortable. After a long time, the employee's hand gets injured.

Furthermore, medical technology progresses and more and more people have longevity. Advanced employees become very common in offices. These advanced employees probably feel laborious when using the conventional hole puncher.

Moreover, another conventional hole puncher has an articulated structure and allows people to easily use the hole puncher. However, the hole puncher has some disadvantages. The moment arm of the hole puncher is short so people still needs to pay much force when operating the hole puncher. The articulated structure is not limited to move in rails and may inappropriately sways so a user cannot smoothly use the hole puncher. The hole puncher sways and becomes loose and even disassembled.

To overcome the shortcomings, the present invention provides a laborsaving hole puncher to mitigate or obviate the aforementioned problems.

### SUMMARY OF THE INVENTION

The main objective of the invention is to provide a laborsaving hole puncher that allows a user to easily punch holes through a stack of paper sheets without strenuous effort.

A laborsaving hole puncher in accordance with the present invention comprises a base, at least one cutter, a top cover and at least one articulated linkage.

The base has at least one bracket. The least one cutter slidably is mounted respectively on the at least one bracket. The top cover is mounted pivotally on the at least one bracket. The least one articulated linkage connects respectively to the at least one bracket, the at least one cutter and the top cover and each articulated linkage has an upper link and a lower link. The upper link is mounted pivotally on the top cover. The lower link is mounted pivotally on the upper link and is mounted pivotally on one bracket and has an intermediate segment mounted to one cutter.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a laborsaving hole puncher in accordance with the present invention;

FIG. 2 is an exploded perspective view of the laborsaving hole puncher in FIG. 1;

FIG. 3 is an exploded perspective view of the articulated linkages and the brackets of the laborsaving hole puncher in FIG. 2;

FIG. 4 is a side view in partial section of the laborsaving hole puncher in FIG. 1;

FIG. 5 is a side view in partial section of a second embodiment of a laborsaving hole puncher in accordance with the present invention;

FIG. 6 is a side view in partial section of a third embodiment of a laborsaving hole puncher in accordance with the present invention;

FIG. 7 is a rear view in partial section of the laborsaving hole puncher in FIG. 1, 5 or 6 with blades of the cutters located in two different levels;

FIG. 8 is a perspective view of a fourth embodiment of a laborsaving hole puncher in accordance with the present invention;

FIG. 9 is a perspective view of a fifth embodiment of a laborsaving hole puncher in accordance with the present invention;

FIG. 10 is a side view in partial section of the laborsaving hole puncher in FIG. 1 marked with lines of lengths, lines of forces and included angles applied to the hole puncher;

FIG. 11 is a schematic diagram of the lines of the lengths, lines of the forces and included angles in FIG. 10; and

FIG. 12 is a side view in partial section of a conventional hole puncher in accordance with the prior art.

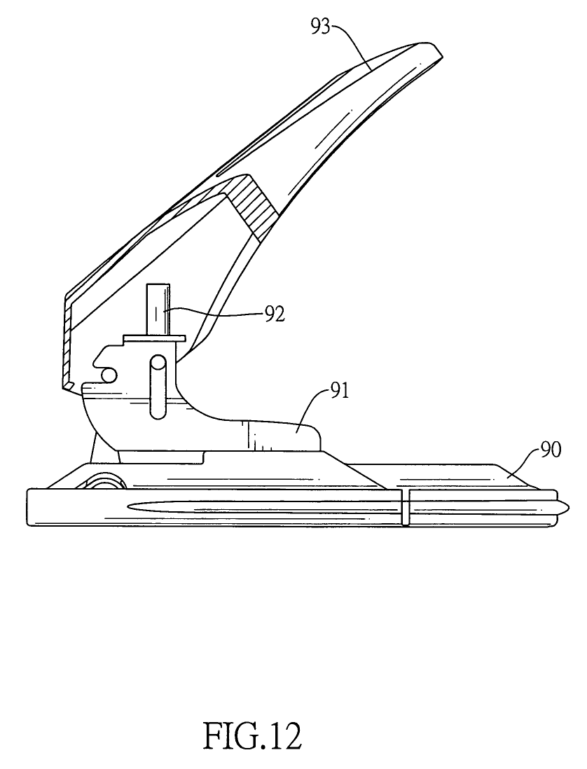

### DETAILED DESCRIPTION OF THE PREFERRED EMBODIMENT

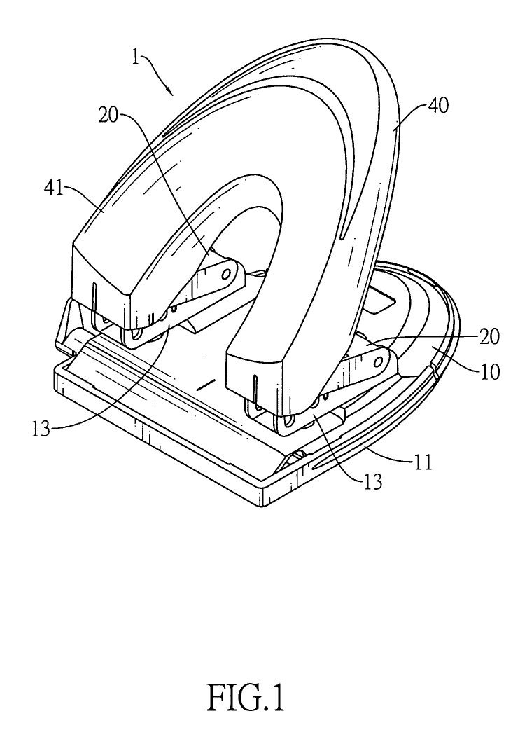

Several embodiments of a laborsaving hole puncher in accordance with the present invention are described hereafter with FIGS. 1-9.

The laborsaving hole puncher may be a single-cutter type or multi-cutter type hole puncher.

### First Embodiment

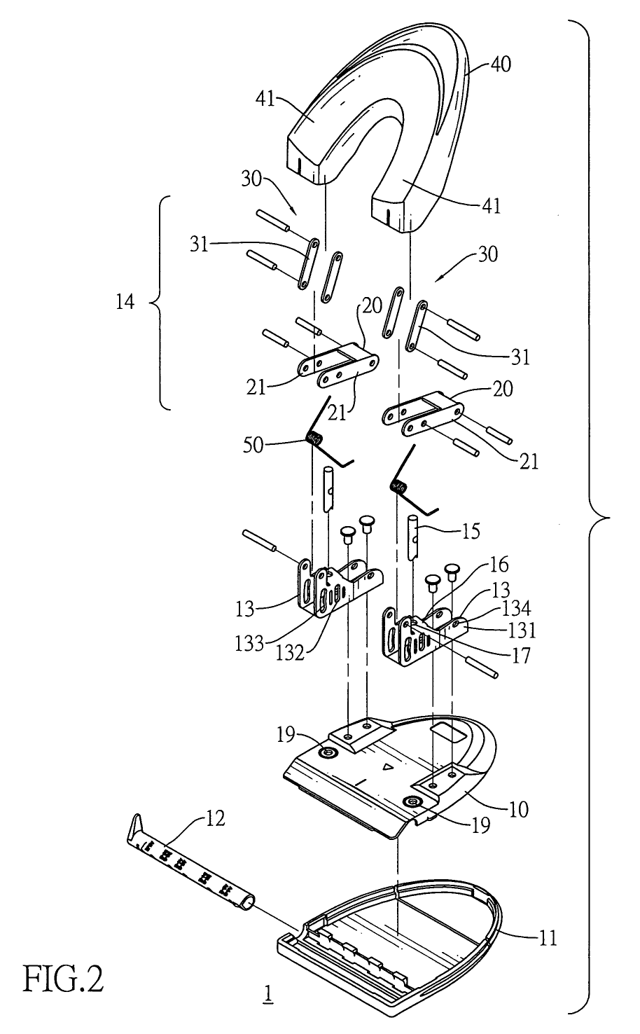

With reference to FIGS. 1 and 2, a first embodiment of the laborsaving hole (1) in accordance with the present invention is a dual-cutter type hole puncher and comprises a base (10), two cutters (15), a top cover (40), two torsion springs (50) and two articulated linkages (14).

The base (10) has a top, a bottom, two cutter holes (19), a bottom pad (11), a ruler (12) and two brackets (13). The cutter holes (19) are defined through the base (10). The bottom pad (11) is mounted detachably on the base (10) and has a top and a cavity defined in the top to receive paper scraps. The ruler (12) is mounted slidably and transversely between the base (10) and the bottom pad (11).

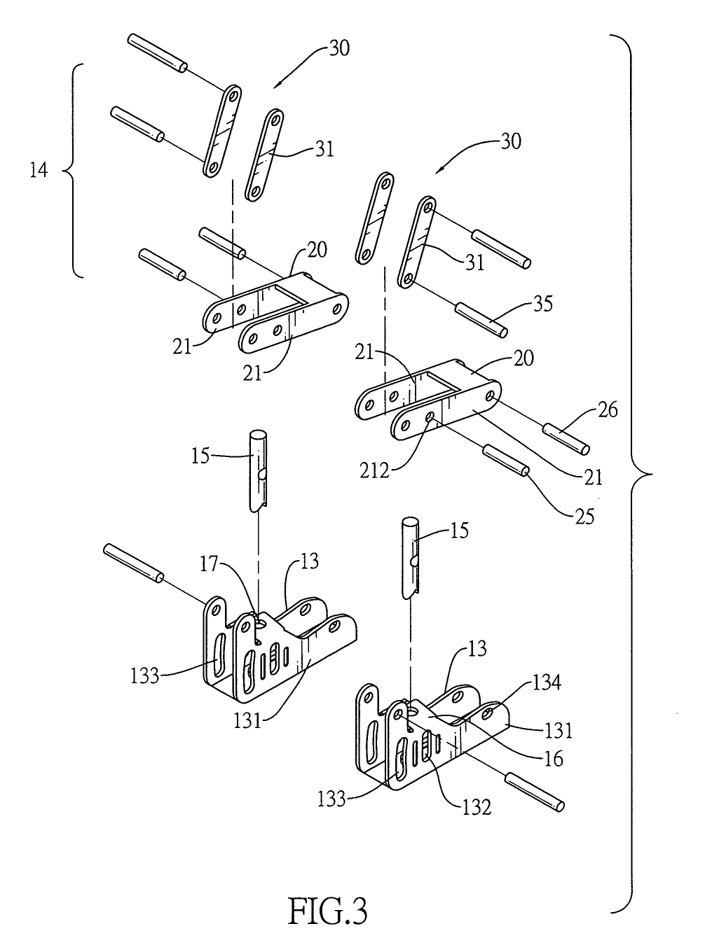

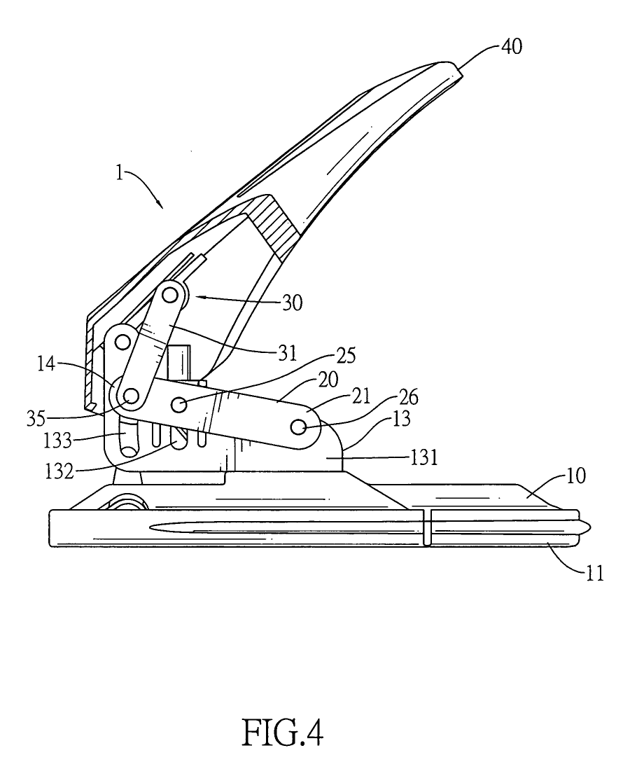

With further reference to FIGS. 3 and 4, the brackets (13) are U-shaped, are mounted on the top of the base (10) and correspond respectively to the cutter holes (19). Each bracket (13) has a front end, a rear end, two wings (131), a partition board (16) and a guide hole (17). The wings (131) are formed and protrude up from the bracket (13) at an interval and each wing (131) has a curved slot (133), a pivot hole (134) and a rail slot (132). The curved slot (133) is defined through the wing (131) near the rear end of the bracket (13). The pivot hole (134) is defined through the wing (131) near the front end of the bracket (13). The rail slot (132) is longitudinal and is defined through the wing (131) between the curved slot (133) and the pivot hole (134). The partition board (16) is mounted between the wings (131). The guide hole (17) is defined through the partition board (16) between the curved slot (133) and the pivot hole (134) and corresponds to the rail slot (132).

The cutters (15) are slidably mounted respectively through the guide holes (17) and the cutter holes (19) to cut paper sheets and each cutter (15) has a bottom end, a pin hole and a blade. The pin hole is defined through the cutter (15). The blade is formed on the bottom end.

The top cover (40) is mounted pivotally one the brackets (13) and has a front, a rear and two extension arms (41). The extension arms (41) extend from the top cover (40) and are mounted respectively on the rear ends of the brackets (13). The top cover (40) allows the user to depress the front to drive the cutters (15) to cut the paper sheets.

The torsion springs (50) are mounted between the base (10) and the top cover (40), correspond respectively to the bracket (13), correspond respectively to the extension arms (41) and bias the front of the top cover (40) upward. Each torsion spring (50) is mounted between a corresponding bracket (13) and a corresponding extension arm (41).

The articulated linkages (14) connect respectively to and correspond respectively to the brackets (13) on the base (10), the cutters (15) and the extension arms (41) of the top cover (40).

Each articulated linkage (14) has an upper link (30) and a lower link (20).

The upper link (30) is mounted pivotally on the top cover (40) and comprises two connection tabs (31) and has a top end, a bottom end and a slot pin (35). The bottom end of the upper link (30) is mounted pivotally and slidably between curved slots (133) in the wings (131) on a corresponding bracket (13). The slot pin (35) extends through the bottom end of the upper link (30) and is slidably mounted in the curved slots (133) in the wings (131) on the bracket (13) and allows the bottom end of the upper link (30) to pivot and slide along the curved slots (133).

The lower link (20) is reverse U-shaped, is mounted pivotally on the upper link (30), is mounted pivotally on a corresponding bracket (13) and has a top end, a bottom end, an intermediate segment, two side tabs (21), a pivot pin (26) and a slide pin (25). The top end of the lower link (20) is mounted pivotally on the bottom end of the upper link (30) by extending the slot pin (35) through the top end of the lower link (20). The bottom end of the lower link (20) is mounted pivotally on the wings (131) on the front end of the bracket (13). The intermediate segment is mounted to a corresponding cutter (15). The side tabs (21) extend from the lower link (20) and each side tab (21) has a top end, a bottom end and a pin hole (212). The pin hole (212) is defined through the side tab (21) between the top end and the bottom end of the lower link (20) and corresponds to the intermediate segment. The pivot pin (26) extends through the bottom end of the lower link (20) and the pivot holes (134) in the wings (131) on the bracket (13) to pivot the lower link (20) on the bracket (13). The pivot pin (26) may extend through the bottom ends of the side tabs (21). The slide pin (25) extends through the intermediate segment of the lower link (20), may extend through the pin holes (212) in the side tabs (21), extends through a corresponding cutter (15) and is mounted slidably in the rail slots (132) in the wings (131) on the bracket (13) to move the cutter (15) up and down.

### Second Embodiment

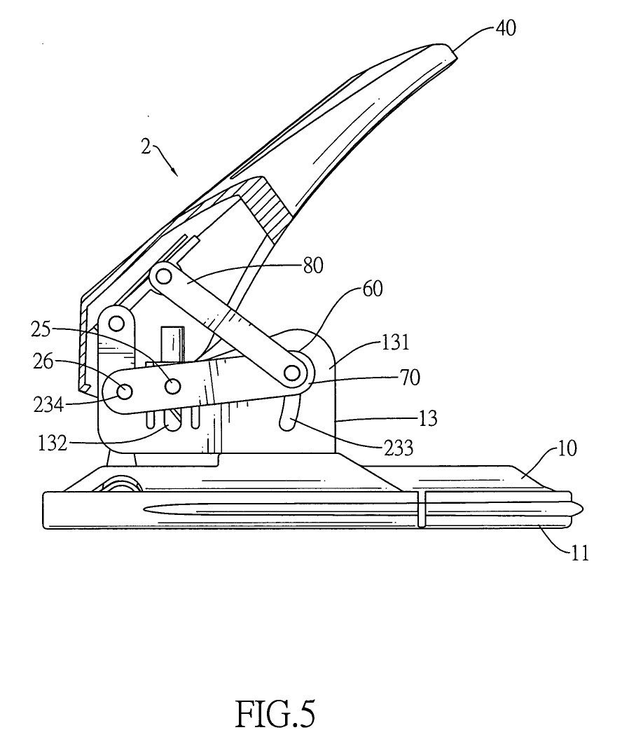

With reference to FIG. 5, a second embodiment of the laborsaving hole puncher (2) in accordance with the present invention is a dual-cutter type hole puncher. Features in the second and first embodiments with same reference numbers are identical and function in the same manner.

The laborsaving hole puncher (2) has each bracket (13) having the curved slots (233) defined respectively through the wings (131) on the bracket (13) near the front end. The pivot hole (234) are defined respectively through wings (131) on the bracket (13) near the rear end.

The articulated linkages (60) connect to the base (10), the cutters (15) and the top cover (40). Each articulated linkage (60) is mounted pivotally on a corresponding bracket (13). The upper link (80) of the articulated linkage (60) has a top end mounted pivotally on the top cover (40). The bottom end of the upper link (80) is mounted pivotally and slidably between the curved slots (233) in the bracket (13) near the front end. The lower link (70) of the articulated linkage (60) has a bottom end mounted pivotally on the wings (131) on the rear end of the bracket (13) by extending the pivot pin (26) through the pivot holes (234) in the bracket (13). The intermediate segment of the lower link (70) connects to a corresponding cutter (15) by extending the slide pin (25) through the rail slots (132) in the wings (131) to move the cutter (15) up and down.

### Third Embodiment

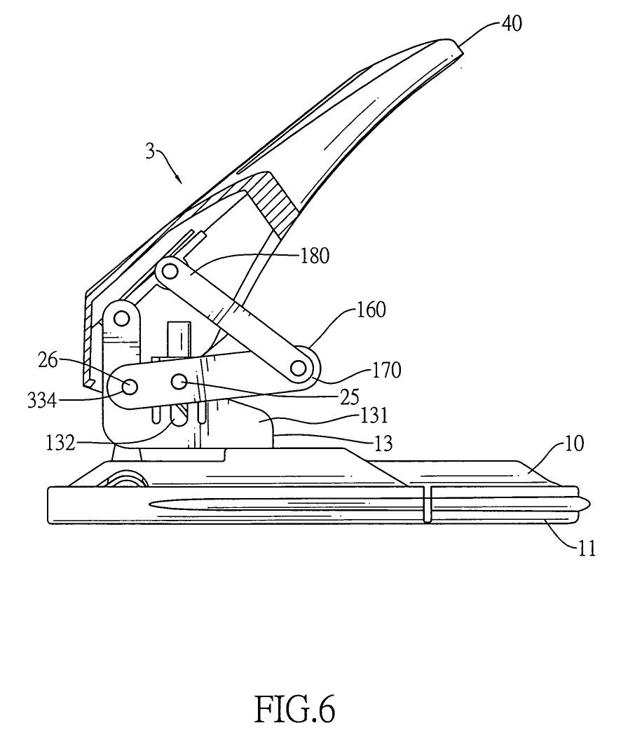

With reference to FIG. 6, a third embodiment of the laborsaving hole puncher (3) is a dual-cutter type hole puncher. Features in the third, first and second embodiments with the same reference numbers are identical and function in the same manner.

Each bracket (13) is implemented with the pivot holes (334) defined respectively through the wings (131) near the rear end of the bracket (13) and without the curved slot. Each articulated linkage (160) has the bottom end of the upper link (180) and the top end of the lower link (170) suspending and separating from a corresponding bracket (13).

The lower link (170) has a bottom end mounted pivotally on the wings (131) on the rear end of a corresponding bracket (13) by extending the pivot pin (26) through the pivot holes (334) in the bracket (13). The intermediate segment of the lower link (170) connects to a corresponding cutter (15) by extending the slide pin (25) through the rail slots (132) in the wings (131).

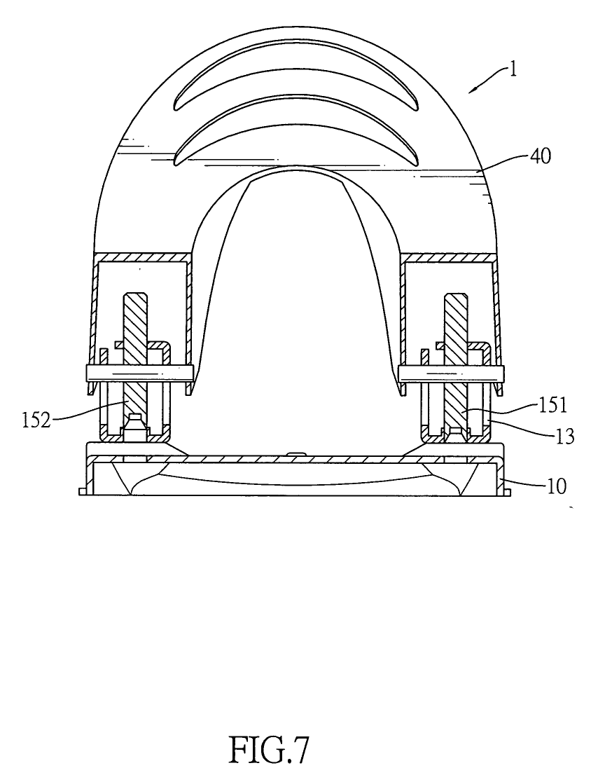

With reference to FIG. 7, the cutters (151, 152) may have the blades located in two different levels. With the blades in the different levels, the cutters (151, 152) successively cut paper sheets when the laborsaving hole puncher is used so that a user may easily punch holes in the paper sheets.

### Fourth Embodiment

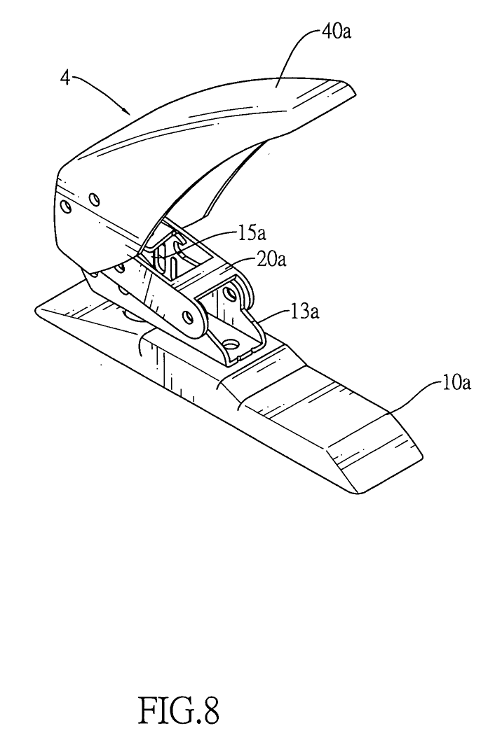

With reference to FIG. 8, a fourth embodiment of the laborsaving hole puncher (4) in accordance with the present invention is a single-cutter type hole puncher and has a base (10a), a single cutter (15a), a single articulated linkage and a top cover (40a). The base (10a) has a single bracket (13a). The articulated linkage has an upper link and a lower link (20a) having structures same as those in the first embodiment.

### Fifth Embodiment

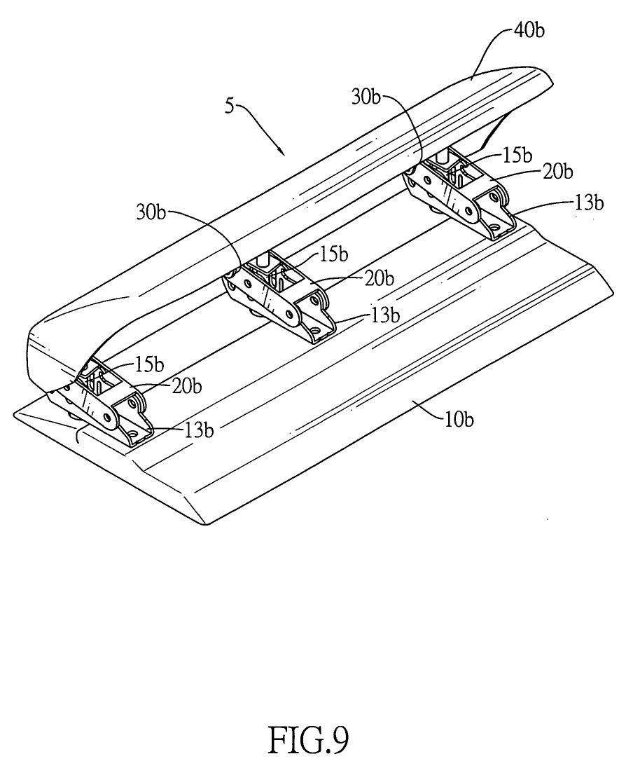

With reference to FIG. 9, a fifth embodiment of the laborsaving hole puncher (5) in accordance with the present invention is a triple-cutter type hole puncher and has a base (10b), three cutters (15b), three articulated linkages and a top cover (40b). The base (10b) has three brackets (13b). Each articulated linkage has an upper link (30b) and a lower link (20b) having structures same as those in the first embodiment.

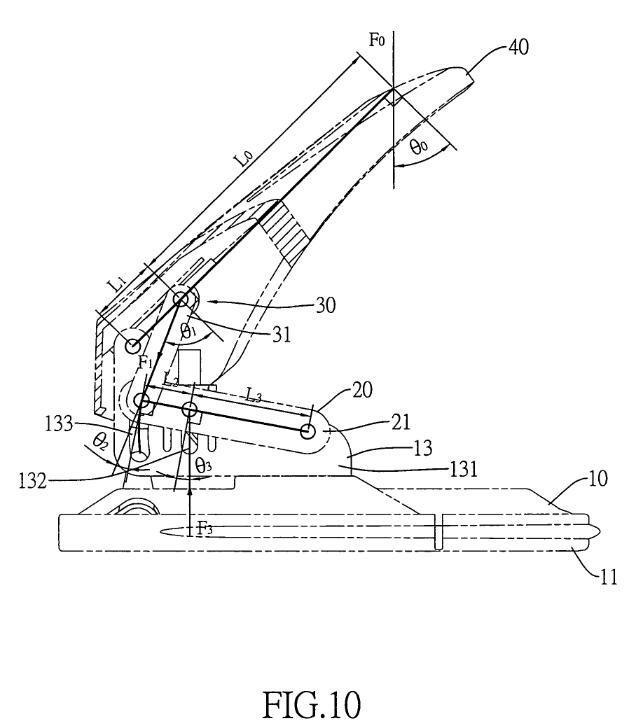

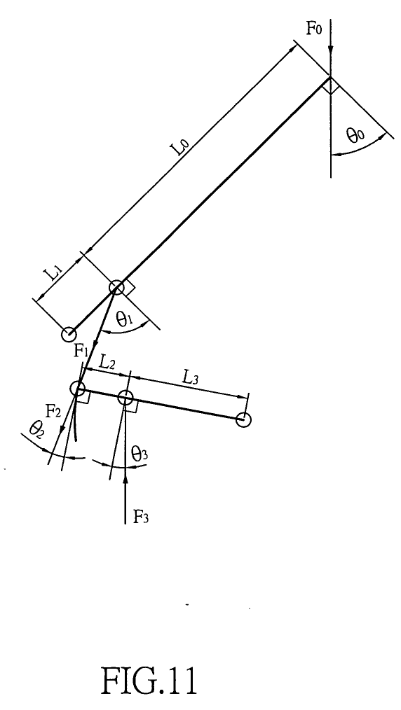

With reference to FIGS. 10 and 11, to prove that the hole puncher of the present invention saves effort over a conventional hole puncher, the following equations are presented to calculate the moment of the hole puncher. The equations are presented with a length (L₀) of the top cover (40), a length (L₁) between the top end of the upper link (30) and a point at which the extension arm (41) pivotally mounted to the bracket (13), a length (L₂) between the slide pin (25) and the slot pin (35), a length (L₃) between the slide pin (25) and the pivot pin (26), an input force (F₀), two stress forces (F₁, F₂), an output or reaction force (F₃) and included angles (θ₀, θ₁, θ₂, θ₃).

F₀×sin(θ₀)=F₁×sin(θ₁)×L₁

F₀×sin(45°)×L₀=F₁×sin(24.061°)×L₁

L₀=130; L₁=18

91.92F₀=7.34F₁

F₁=12.52F₀

F₃×sin(90−θ₃)×L₃=F₂×L₂

F₃×sin(79.193)×L₃=F₂×L₂

F₂=F₁×sin(90−θ₂)

F₂=F₁×sin(79.868)

F₃×sin(79.3193)×L₃=F₁×sin(79.868)×L₂

L₂=45; L₃=32

31.43F₃=44.3F₁

F₁=0.71F₃

12.52F₀=0.71F₃

F₃=17.63F₀

As a result of the equations, the laborsaving hole puncher has ratio of the input force (F₀) and the output force (F₃) being 1:17.63.

A conventional hole puncher has a ratio of an input force and an output force being 1:7.19.

Effort-saving rate=(17.63−7.19)/17.63=0.59323=59.323%

The articulated linkages make people easily conveniently use the laborsaving hole puncher (1, 2, 3, 4, 5) without strenuous effort. Therefore, weak people such as females and elders may safely use the laborsaving hole puncher (1, 2, 3, 4, 5) without getting his/her hands injured. Moreover, the curved slots (133, 233) in each bracket (13) guide and prevent the top end of the lower link (20, 70) and the bottom end of the upper link (30, 80) from swaying inadvertently. Therefore, the laborsaving hole puncher (1, 2, 4, 5) is durable and people may smoothly use the laborsaving hole puncher (1, 2, 4, 5).

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A laborsaving hole puncher comprising:
a base having at least one U-shaped bracket mounted on the base and each one of the at least one bracket having
a front end;
a rear end;
two wings formed on the bracket at an interval and each wing having a curved slot defined through the wing; and
a partition board mounted the wings and having a guide hole defined through the partition board;
at least one cutter slidably mounted respectively through the guide hole in the at least one bracket and slidably mounted through the base;
a top cover mounted pivotally on the at least one bracket to be depressed to drive the at least one cutter and having a front; and
at least one articulated linkage corresponding respectively to and connecting respectively to the at least one bracket on the base, connecting respectively to the at least one cutter, connecting to the top cover and each one of the at least one articulated linkage having
an upper link mounted pivotally on the top cover and having a top end mounted pivotally on the top cover and a bottom end pivotally and slidably between the curved slots in the wings on a corresponding one of the at least one bracket; and
a lower link mounted pivotally on the upper link, mounted pivotally on the corresponding bracket and having a top end mounted pivotally on the bottom end of the upper link, a bottom end mounted pivotally on the wings on the corresponding bracket and an intermediate segment mounted to a corresponding one of the at least one cutter.

2. The laborsaving hole puncher as claimed in claim 1, wherein:
the base has two brackets; and
the laborsaving hole puncher has two cutters and two articulated linkages corresponding respectively to the brackets and the cutters.

3. The laborsaving hole puncher as claimed in claim 2, wherein each cutter has a bottom end and a blade formed on the bottom end and the blades of the cutters are located in different levels.

4. The laborsaving hole puncher as claimed in claim 1, wherein each one of the at least one bracket has the curved slots in the wings being near the rear end of the bracket.

5. The laborsaving hole puncher as claimed in claim 1, wherein the lower link of each one of the at least one articulated linkage is reverse U-shaped and further has two side tabs extending from the lower link and each side tab having a top end and a bottom end; and
a pivot pin extending through the bottom ends of the side tabs and extending through the wings on a corresponding one of the at least one bracket to pivot the lower link on the corresponding bracket.

6. The laborsaving hole puncher as claimed in claim 1, wherein:
the upper link of each one of the at least one articulated linkage comprises two connection tabs; and
each one of the at least one articulated linkage further has a slot pin extending through the bottom end of the upper link and the top end of the lower link and mounted slidably in the curved slots in the wings on a corresponding one of the at least one bracket.

7. The laborsaving hole puncher as claimed in claim 1, wherein at least one torsion spring is mounted respectively between the at least one bracket and the top cover to bias the front of the top cover upward.

8. A laborsaving hole puncher comprising:
a base having at least one U-shaped bracket mounted on the base and each one of the at least one bracket having
a front end;
a rear end;
two wings formed on the bracket at an interval; and
a partition board mounted the wings and having a guide hole defined through the partition board;
at least one cutter slidably mounted respectively through the guide hole in the at least one bracket and slidably mounted through the base;
a top cover mounted pivotally on the at least one bracket to be depressed to drive the at least one cutter and having a front; and
at least one articulated linkage corresponding respectively to and connecting respectively to the at least one bracket on the base, connecting respectively to the at least one cutter, connecting to the top cover and each one of the at least one articulated linkage having
an upper link mounted pivotally on the top cover and having a top end mounted pivotally on the top cover and a bottom end; and
a lower link mounted pivotally on the upper link, mounted pivotally on a corresponding one of the at least one bracket and having a top end mounted pivotally on the bottom end of the upper link, a bottom end mounted pivotally on the wings on the corresponding bracket and an intermediate segment mounted to a corresponding one of the at least one cutter.

9. The laborsaving hole puncher as claimed in claim 8, wherein:
the base has two brackets; and
the laborsaving hole puncher has two cutters and two articulated linkages corresponding respectively to the brackets and the cutters.

10. The laborsaving hole puncher as claimed in claim 9, wherein each cutter has a bottom end and a blade formed on the bottom end and the blades of the cutters are located in two different levels.

11. The laborsaving hole puncher as claimed in claim 8, wherein the base further has a bottom pad mounted detachably on the base and having a top and a cavity defined in the top and adapted to receive paper scraps.

12. The laborsaving hole puncher as claimed in claim 8, wherein the lower link of each one of the at least one articulated linkage is reverse U-shaped and further has
two side tabs extending from the lower link and each side tab having a top end and a bottom end; and
a pivot pin extending through the bottom ends of the side tabs and extending through the wings on a corresponding one of the at least one bracket to pivot the lower link on the corresponding bracket.

13. The laborsaving hole puncher as claimed in claim 8, wherein:
the upper link of each one of the at least one articulated linkage comprises two connection tabs; and
each one of the at least one articulated linkage further has a slot pin extending through the bottom end of the upper link and the top end of the lower link.

14. The laborsaving hole puncher as claimed in claim 13, wherein at least one torsion spring is mounted respectively between the at least one bracket and the top cover to bias the front of the top cover upward.
